(19) United States
(12) Patent Application Publication
(10) Pub. No.: US 2020/0379966 A1
(43) Pub. Date: Dec. 3, 2020

(54) METHOD AND SYSTEM FOR IMPLEMENTING A DECENTRALIZED STORAGE POOL FOR AUTONOMOUS VEHICLE NAVIGATION GUIDANCE INFORMATION

(71) Applicant: EMC IP Holding Company LLC, Hopkinton, MA (US)

(72) Inventors: Pengfei Wu, Shanghai (CN); Kun Wang, Beijing (CN); Assaf Natanzon, Tel Aviv (IL); Zhenzhen Lin, Shanghai (CN); Si Chen, Shanghai (CN)

(21) Appl. No.: 16/424,542

(22) Filed: May 29, 2019

(51) Int. Cl. G06F 16/22; G06F 16/29; G05D 1/02

(52) U.S. Cl. CPC G06F 16/2255; G06F 16/29; G05D 2201/0213; G05D 1/0276; G05D 1/0212

(57) ABSTRACT

A method and system for implementing a decentralized storage pool for autonomous vehicle navigation guidance information. Specifically, the method and system disclosed herein entail creating a decentralized storage pool aggregated and virtualized from disparate physical storage resources across autonomous vehicles, edge clusters, and/or the cloud to retain ever increasing amounts of data generated and/or employed through autonomous vehicle map-based localization. Further, a content-addressable, peer-to-peer (P2P) distributed file system may be employed to manage the organization of information on, and coordinate filesystem operations pertinent to, the decentralized storage pool.

### BACKGROUND

Regarding autonomous driving technology, a core enabler of the technology is directed to map-based localization. Map-based localization entails map registration processes, which produce and employ exorbitant amounts of data. The aforementioned data is quickly surpassing the exa-byte (EB) and/or zetta-byte (ZB) range, which no existing centralized data storage system can maintain.

### BRIEF DESCRIPTION OF DRAWINGS

FIG. 1 shows a system in accordance with one or more embodiments of the invention.

FIG. 2A shows a distributed hash table in accordance with one or more embodiments of the invention.

FIG. 2B shows a mutable namespace registry in accordance with one or more embodiments of the invention.

FIG. 3 shows a flowchart describing a method for publishing map metadata digests to a distributed hash table in accordance with one or more embodiments of the invention.

FIG. 4 shows a flowchart describing a method for publishing processed map metadata digests to a distributed hash table in accordance with one or more embodiments of the invention.

FIG. 5 shows a flowchart describing a method for preloading processed map data for upcoming regions in accordance with one or more embodiments of the invention.

FIG. 6 shows a computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

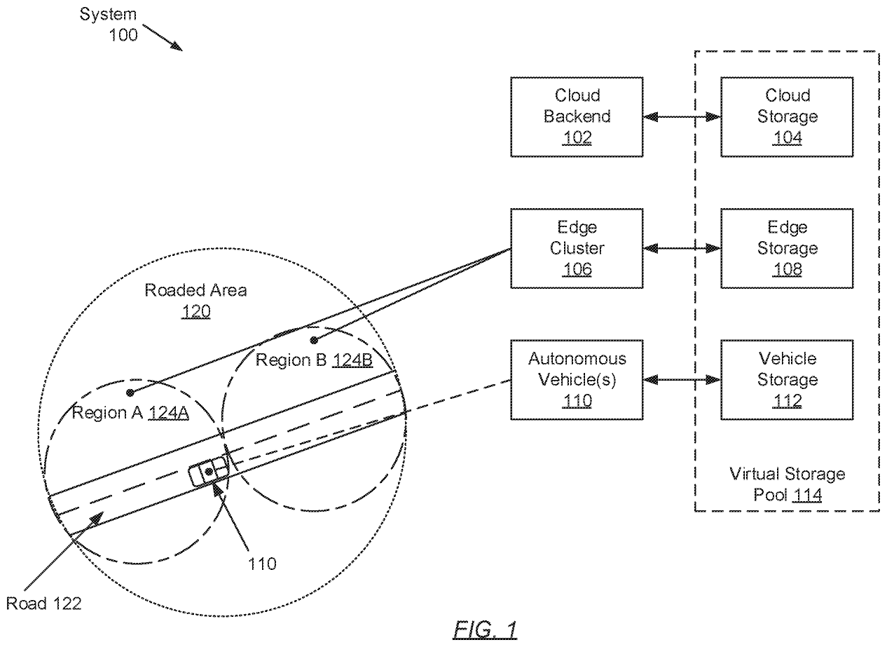

In the following description of FIGS. 1-6, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for implementing a decentralized storage pool for autonomous vehicle navigation guidance information. Specifically, one or more embodiments of the invention entails creating a decentralized storage pool aggregated and virtualized from disparate physical storage resources across autonomous vehicles, edge clusters, and/or the cloud to retain ever increasing amounts of data generated and/or employed through autonomous vehicle map-based localization. Further, a content-addressable, peer-to-peer (P2P) distributed file system may be employed to manage the organization of information on, and coordinate filesystem operations pertinent to, the decentralized storage pool.

FIG. 1 shows a system in accordance with one or more embodiments of the invention. The system (100) may represent a decentralized information system for maintaining navigation guidance information generated and/or employed by autonomous vehicles. Accordingly, the system (100) may include a cloud backend (102), one or more edge clusters (106), one or more autonomous vehicles (110), and a virtual storage pool (114). Each of these system (100) components is described below.

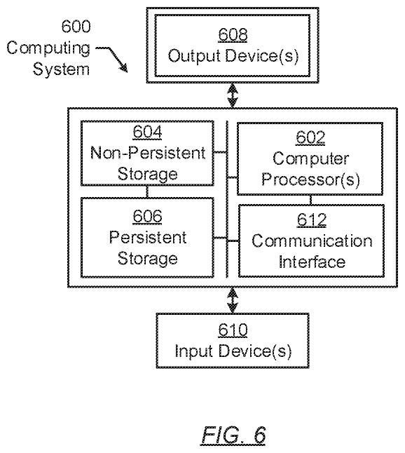

In one embodiment of the invention, the cloud backend (102) may represent a cloud computing resource pool, wherefrom cloud computing resources (e.g., cloud storage (104)) may be provisioned. The cloud backend (102) may be implemented using one or more servers (not shown). Each server may be a physical or virtual server residing in a cloud computing environment. Additionally or alternatively, the cloud backend (102) may be implemented using one or more computing systems similar to the exemplary computing system shown in FIG. 6. Furthermore, cloud computing resources may include any subset or all of the following computing system resources: one or more network resources, one or more compute resources, one or more virtualization resources, and one or more storage resources (e.g., cloud storage (104)). Cloud computing resources is not limited to the aforementioned examples.

In one embodiment of the invention, a network resource may refer to a measurable quantity of a network-relevant resource type that can be requested, allocated, and consumed. A network-relevant resource type may pertain to a physical device (i.e., hardware), a logical intelligence (i.e., software), or a combination thereof, which provides networking functionality. Further, each network-relevant resource type may be quantified through a respective base unit. By way of examples, a network interface card (NIC) or a network adapter may represent network-relevant resource types, which may be specified in base units of bits per second (bps).

In one embodiment of the invention, a compute resource may refer to a measurable quantity of a compute-relevant resource type that can be requested, allocated, and consumed. A compute-relevant resource type may pertain to a physical device (i.e., hardware), a logical intelligence (i.e., software), or a combination thereof, which provides computing functionality. Further, each compute-relevant resource type may be quantified through a respective base unit. By way of an example, a central processing unit (CPU) and/or a graphics processing unit (CPU) may represent compute-relevant resource types, which may be specified in base units of cores. By way of another example, memory (e.g., random access memory (RAM)) may represent another compute-relevant resource type, which may be specified in base units of bytes.

In one embodiment of the invention, a virtualization resource may refer to a measurable quantity of a virtualization-relevant resource type that can be requested, allocated, and consumed. A virtualization-relevant resource type may pertain to a physical device (i.e., hardware), a logical intelligence (i.e., software), or a combination thereof, which provides virtualization functionality. Further, each virtualization-relevant resource type may be quantified through a respective base unit. By way of an example, a virtual machine or a container represent virtualization-relevant resource types, which may be specified in base units of virtual CPUs (vCPU), where each vCPU may be viewed as a single physical CPU core.

In one embodiment of the invention, a storage resource may refer to a measurable quantity of a storage-relevant resource type that can be requested, allocated, and consumed. A storage-relevant resource type may pertain to a physical device (i.e., hardware), a logical intelligence (i.e., software), or a combination thereof, which provides data storage functionality. Further, each storage-relevant resource type may be quantified through a respective base unit. By way of examples, a hard disk drive (HDD), a solid state drive (SSD), and flash memory may each be a storage-relevant resource type, which may each be specified in base units of bytes.

In one embodiment of the invention, the cloud backend (102) may provision cloud computing resources for any subset or all of the following reasons: (a) to store replicas of any information (e.g., map data and/or map metadata) disclosed herein should there be an insufficient number of autonomous vehicles (110) within and/or edge servers (not shown) associated with a given region (124A, 124B); (b) to handle compute-intensive workloads such as, for example, autonomous vehicle (110) artificial intelligence (AI) optimization; (c) to archive any information disclosed herein; and (d) to generate a dashboard using any information disclosed herein. The provisioning of cloud computing resources, by the cloud backend (102), is not limited to the aforementioned examples.

In one embodiment of the invention, an edge cluster (106) may represent a collection of edge server(s) and/or edge computing system(s) (see e.g., FIG. 6). Collectively, an edge cluster (106) may be associated with, and thus responsible for, a given region (124A, 124B) of a roaded area (120). Each edge cluster (106) may reside in a datacenter geographically located within or near the given region (124A, 124B) with which the edge cluster (106) may be associated. A roaded area (120) may refer to any granularity of terrain that may be provided with or traversed by at least one path (e.g., road, highway, interstate, tunnel, trail, etc.) (122) that which any vehicle (e.g., an autonomous vehicle (110)) may use. Further, a roaded area (120) may refer to any granularity of terrain that may include at least one region (124A, 124B).

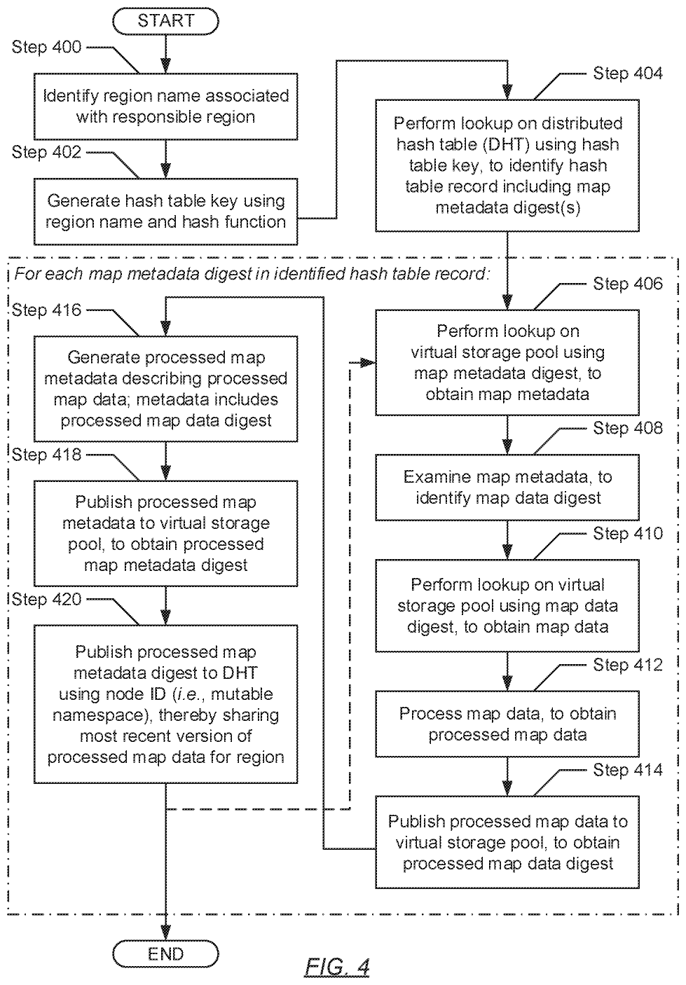

In one embodiment of the invention, in being responsible for a given region (124A, 124B), an edge cluster (106) may include functionality to: collect and process map data generated by autonomous vehicle(s) (110) navigating within or through the given region (124A, 124B) (see e.g., FIG. 4); provide or share updated navigation guidance information (e.g., map data and/or map metadata), which may be obtained and employed by autonomous vehicle(s) (110) navigating within or through the given region (124A, 124B); maintain an availability of navigation guidance information, for the given region (124A, 124B), by generating and tracking replicas of the navigation guidance information across autonomous vehicle(s) (110), the edge cluster (106), and/or the cloud backend (102); assist autonomous vehicles (110), navigating within or through the given region (124A, 124B), in discovering each other; and establish peer-to-peer (P2P) connections.

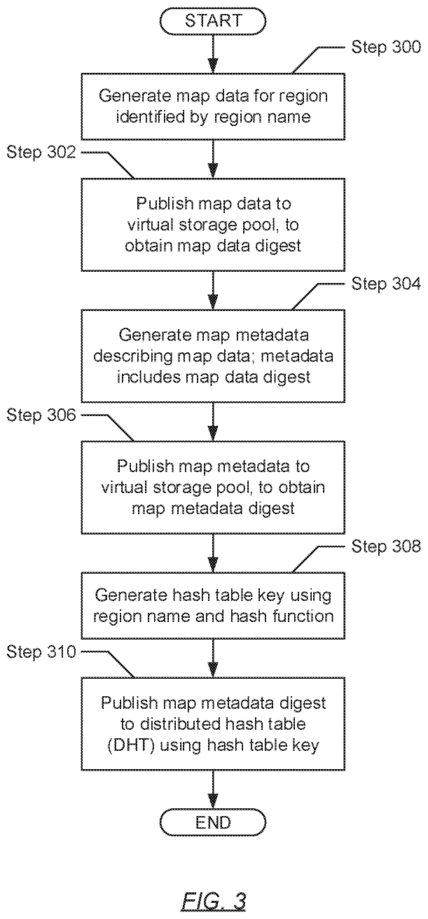

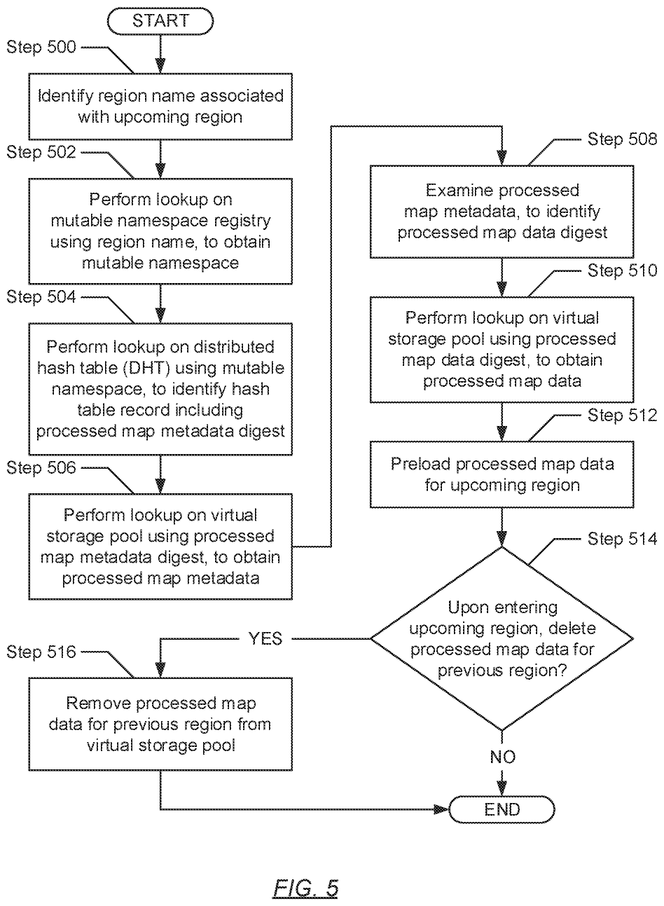

In one embodiment of the invention, an autonomous vehicle (110) may represent any vehicle that may include functionality to self-drive (or guide itself) without, or with minimal, human intervention. Examples of an autonomous vehicle (110) may include, but are not limited to, a car, a truck, a bus, or any other wheeled vehicle that may be propelled by an internal combustion engine, an electrical engine, a hybrid internal combustion-electrical engine, etc. Further, an autonomous vehicle (110) may include one or more on-board computing systems (see e.g., FIG. 6) that may be responsible for overseeing and implementing the various safety, performance, convenience, diagnostic, and other aspects of the autonomous vehicle (110); operating and regulating the various mechanical and electrical components of the autonomous vehicle (110); and implementing other roles pertinent to the autonomous vehicle (110). At least a subset of the on-board computing system(s) may include responsibility to implement the self-driving (or self-guiding) functionality of the autonomous vehicle (110). Moreover, at least a portion of the aforementioned responsibility may entail navigation information generation (see e.g., FIG. 3) and navigation information attainment (see e.g., FIG. 5).

In one embodiment of the invention, the virtual storage pool (114) may refer to shared data storage aggregated and virtualized from disparate physical storage resources. These disparate physical storage resources may include at least a portion of vehicle storage (112) residing on the autonomous vehicle(s) (110), at least a portion of edge storage (108) residing on or operatively connected to the edge cluster(s) (106), and/or cloud storage (104) provisioned from the cloud backend (102). Cloud storage (104), edge storage (108), and/or vehicle storage (112) may be implemented using one or more physical storage devices (not shown). Further, each physical storage device may be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the virtual storage pool (114) may employ a content-addressable, peer-to-peer (P2P) distributed file system to organize information, and manage filesystem pertinent operations, across the virtual storage pool (114). By way of an example, the virtual storage pool (114) may employ the Interplanetary File System (IPFS). The IPFS is described in further detail in J. Benet, “IPFS—Content Addressed, Versioned, P2P File System,” arXiv:1407.3561[cs], July 2014, which is hereby referenced and incorporated in its entirety.

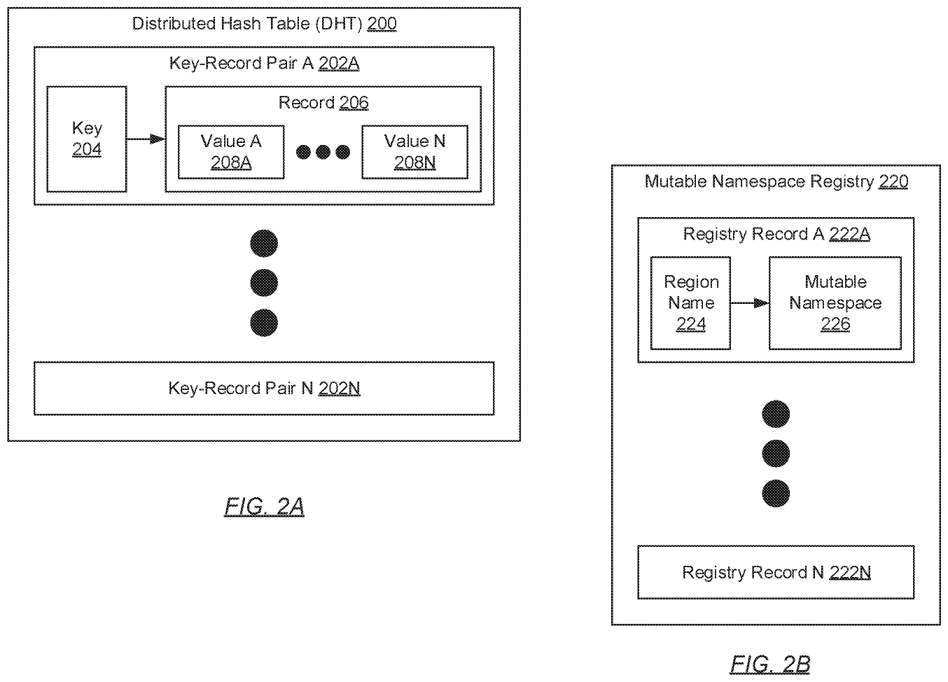

FIG. 2A shows a distributed hash table (DHT) in accordance with one or more embodiments of the invention. The DHT (200) may represent a hash table (e.g., data structure) that stores and/or maintains an index for various information stored throughout a virtual storage pool (see e.g., FIG. 1). To that end, the DHT (200) may include one or more key-record pairs (202A-202N). Each key-record pair (202A-202N) may include a mapping associating a key (also referred herein as a hash table key) (204) and a record (also referred herein as a hash table record) (206). Each of these data items is described below.

In one embodiment of the invention, the key (204) may refer to an identifier with which the record (206) may be associated, and/or an index with which the key-record pair (202A-202N) may be associated. The key (204) may be expressed through any fixed-length alphanumeric character string. Accordingly, the key (204) may represent a cryptographic digest (e.g., a region name digest, a node ID or mutable namespace, etc.), which may be obtained from processing any arbitrary-length data using any existing cryptographic hash function or algorithm (e.g., Secure Hash Algorithm 1 (SHA-1), SHA-2, Message Digest Algorithm 5 (MD5), etc.). Furthermore, in one embodiment of the invention, the record (206) may refer to a data container that stores one or more values (208A-208N). Each value (208A-208N) may refer to a metadata digest (e.g., a map metadata digest or a processed map metadata digest). The metadata digest may reference a virtual storage address, in the virtual storage pool, in which autonomous vehicle navigation guidance information (e.g., map data and/or metadata), generated by autonomous vehicles or edge clusters, may be stored or located.

FIG. 2B shows a mutable namespace registry in accordance with one or more embodiments of the invention. The mutable namespace registry (220) may represent a data structure that stores and/or maintains region-to-namespace mappings. Accordingly, the mutable namespace registry (220) may track these aforementioned mappings through one or more registry records (222A-222N). Each registry record (222A-222N) maintains a single region-to-namespace mapping and, subsequently, includes a region name (224) and a mutable namespace (226). Each of these data items is described below.

In one embodiment of the invention, the region name (224) may refer to a prescribed human-readable character string that may be assigned to (or associated with) a region. A region may refer to at least a portion of a roaded area (described above) (see e.g., FIG. 1) for which an edge cluster may be responsible. Furthermore, the mutable namespace (226) may refer to a virtual storage address, in the virtual storage pool, directed to a virtual storage directory assigned to the aforementioned edge cluster. The mutable namespace (226) may be expressed as a cryptographic digest, which may be generated from processing a public-key infrastructure (PKI) public key, associated with the edge cluster, through any existing cryptographic hash function or algorithm (e.g., Secure Hash Algorithm 1 (SHA-1), SHA-2, Message Digest Algorithm 5 (MD5), etc.). Moreover, the mutable namespace (226) may enable the virtual storage address, directed to the virtual storage directory, to remain static (i e , immutable), while the content stored in virtual storage directory may be dynamic (or capable of changing) (i.e., mutable). The mutable namespace (226) may also be referred herein as the node identifier (ID) or peer ID associated with the edge cluster.

FIG. 3 shows a flowchart describing a method for publishing map metadata digests to a distributed hash table (DHT) in accordance with one or more embodiments of the invention. The various steps outlined below may be performed by an autonomous vehicle (see e.g., FIG. 1). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 3, in Step 300, map data for a region is generated. In one embodiment of the invention, the region may be identified by a prescribed human-readable region name that may be expressed through a character string (e.g., “Hwy 1-04” designating a fourth region along California State Highway 1). Further, the map data for the region may include, but is not limited to, three-dimensional (3D) light detection and ranging (LiDAR) data, two-dimensional (2D) images, simultaneous localization and mapping (SLAM) point-cloud data, and any other real-time data pertinent to autonomous vehicle map-based localization.

In Step 302, the map data (generated in Step 300) is published to a virtual storage pool (see e.g., FIG. 1). Specifically, in one embodiment of the invention, the map data may be stored as a data object (e.g., a file) in (or under) a virtual storage directory, of the virtual storage pool, assigned to or associated with the autonomous vehicle. The virtual storage pool may refer to shared data storage aggregated and virtualized from disparate physical storage resources (e.g., vehicle storage, edge storage, and cloud storage). Furthermore, publishing the map data to the virtual storage pool may result in the return (or obtaining) of a map data digest. The map data digest may refer to a unique alphanumeric fingerprint that not only identifies the map data, but also identifies a virtual storage address, in the virtual storage pool, where the map data resides. The map data digest may also be referred herein as the map data content identifier (CID), which may be obtained by processing the map data through any existing cryptographic hash function or algorithm (e.g., Secure Hash Algorithm 1 (SHA-1), SHA-2, Message Digest Algorithm 5 (MD5), etc.). Moreover, the virtual storage address may map to a physical storage address in the hardware vehicle storage, residing on the autonomous vehicle, wherein the map data may be consolidated.

In Step 304, map metadata is generated. In one embodiment of the invention, map metadata may refer to information that describes the map data (generated in Step 300). By way of examples, map metadata may include: Global Positioning System (GPS) coordinate data, which may reference the precise geographic location at which the map data had been generated; the map data digest (obtained in Step 302); and a creation timestamp encoding a date and/or time when which the map data had been generated. Map metadata is not limited to the aforementioned examples.

In Step 306, the map metadata (generated in Step 304) is published to the virtual storage pool. Specifically, in one embodiment of the invention, the map metadata may be stored as a data object (e.g., a file) in (or under) a virtual storage directory, of the virtual storage pool, assigned to or associated with the autonomous vehicle. Furthermore, publishing the map metadata to the virtual storage pool may result in the return (or obtaining) of a map metadata digest. The map metadata digest may refer to a unique alphanumeric fingerprint that not only identifies the map metadata, but also identifies a virtual storage address, in the virtual storage pool, where the map metadata resides. The map metadata digest may also be referred herein as the map metadata CID, which may be obtained by processing the map metadata through any existing cryptographic hash function or algorithm (e.g., Secure Hash Algorithm 1 (SHA-1), SHA-2, Message Digest Algorithm 5 (MD5), etc.). Moreover, the virtual storage address may map to a physical storage address in the hardware vehicle storage, residing on the autonomous vehicle, wherein the map metadata may be consolidated.

In Step 308, a hash table key is generated. In one embodiment of the invention, the hash table key may refer to a unique identifier or index, which may map to a corresponding record, in a distributed hash table (DHT) (described above) (see e.g., FIG. 2A). Further, generation of the hash table key may entail processing the region name (identifying the region mentioned in Step 300) through any existing cryptographic hash function or algorithm (e.g., Secure Hash Algorithm 1 (SHA-1), SHA-2, Message Digest Algorithm 5 (MD5), etc.).

In Step 310, the map metadata digest (obtained in Step 306) is published to the DHT using the hash table key (generated in Step 308). In one embodiment of the invention, publishing of the map metadata digest to the DHT, using the hash table key, may entail: performing a lookup on the DHT using the hash table key, to identify a record (also referred herein as a hash table record) with which the hash table key is linked; and adding (or storing) the map metadata digest to/in the identified record.

FIG. 4 shows a flowchart describing a method for publishing processed map metadata digests to a distributed hash table (DHT) in accordance with one or more embodiments of the invention. The various steps outlined below may be performed by an edge cluster (see e.g., FIG. 1). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 4, in Step 400, a region name is identified. In one embodiment of the invention, the region name may refer to a prescribed, human-readable character string that identifies a responsible region. In turn, the responsible region may be refer to a region (or a portion of roaded area) (see e.g., FIG. 1) for which the edge cluster may be responsible. Further, the region name may be identified or retrieved from an in-memory data structure, data object, or memory address.

In Step 402, a hash table key is generated. In one embodiment of the invention, the hash table key may refer to a unique identifier or index, which may map to a corresponding record, in a distributed hash table (DHT) (described above) (see e.g., FIG. 2A). Further, generation of the hash table key may entail processing the region name (identified in Step 400) through any existing cryptographic hash function or algorithm (e.g., Secure Hash Algorithm 1 (SHA-1), SHA-2, Message Digest Algorithm 5 (MD5), etc.).

In Step 404, a lookup is performed on the DHT using the hash table key (generated in Step 402). Subsequently, in one embodiment of the invention, a record (also referred herein as a hash table record) may be identified based on the lookup. The record may be linked (or mapped) to the hash table key in the DHT. Further, the record may include one or more map metadata digest(s). A map metadata digest may refer to a unique alphanumeric fingerprint that not only identifies a given map metadata, but also identifies a given virtual storage address, in a virtual storage pool (see e.g., FIG. 1), where the given map metadata may reside.

In one embodiment of the invention, the remaining subset of steps (i.e., Steps 406 through 420) outlining the method shown in FIG. 4 may be repeated for each map metadata digest of a subset or all of the map metadata digest(s) (stored in the record identified in Step 404). When considering a subset of the map metadata digest(s), the subset may represent one or more map metadata digest(s), which have yet to be processed by the edge cluster.

Returning to the flowchart, in Step 406, a lookup is performed on the virtual storage pool using the map metadata digest (i.e., a current map metadata digest being processed). As mentioned above, the map metadata digest identifies a virtual storage address in the virtual storage pool. In one embodiment of the invention, the virtual storage address therefore identifies a location in the virtual storage pool wherein map metadata, from which the map metadata digest had been derived, may reside and wherefrom the map metadata may be retrieved (or obtained).

In Step 408, the map metadata (obtained in Step 406) is examined. In one embodiment of the invention, examination of the map metadata may entail identifying the various separate pieces of information (or data items) that which form the map metadata. From examining the map metadata, at least a map data digest is identified. The map data digest may refer to a unique alphanumeric fingerprint that not only identifies a given map data, but also identifies a given virtual storage address, in the virtual storage pool, where the given map data may reside.

In Step 410, a lookup is performed on the virtual storage pool using the map data digest (identified in Step 408). In one embodiment of the invention, the map data digest (i.e., virtual storage address) may identify a location in the virtual storage pool wherein map data, from which the map data digest had been derived, may reside and wherefrom the map data may be retrieved (or obtained).

In Step 412, the map data (obtained in Step 410) is processed. In one embodiment of the invention, processing of the map data may entail any subset or all of the following processes, techniques, or algorithms being applied to, or being performed using, the map data: point cloud registration (e.g., interest or key points identification, feature descriptors estimation, correspondence estimation (matching), correspondence rejection, and transformation estimation); and point cloud triangulation (e.g., using Poisson Surface Reconstruction (PSR)). Processing of the map data is not limited to the aforementioned examples. Further, processed map data may result from processing the map data.

In Step 414, the processed map data (obtained in Step 412) is published to the virtual storage pool. Specifically, in one embodiment of the invention, the processed map data may be stored as a data object (e.g., a file) in (or under) a virtual storage directory, of the virtual storage pool, assigned to or associated with the edge cluster. Furthermore, publishing the processed map data to the virtual storage pool may result in the return (or obtaining) of a processed map data digest. The processed map data digest may refer to a unique alphanumeric fingerprint that not only identifies the processed map data, but also identifies a virtual storage address, in the virtual storage pool, where the processed map data resides. The processed map data digest may also be referred herein as the processed map data content identifier (CID), which may be obtained by processing the processed map data through any existing cryptographic hash function or algorithm (e.g., Secure Hash Algorithm 1 (SHA-1), SHA-2, Message Digest Algorithm 5 (MD5), etc.). Moreover, the virtual storage address may map to a physical storage address in the hardware edge storage, residing on the edge cluster, wherein the processed map data may be consolidated.

In Step 416, processed map metadata is generated. In one embodiment of the invention, processed map metadata may refer to information that describes the processed map data (obtained in Step 412). By way of examples, processed map metadata may include: Global Positioning System (GPS) coordinate data, which may reference the precise geographic location at which the map data (obtained in Step 410) had been generated (which may be copied over from the map metadata (obtained in Step 406)); the processed map data digest (obtained in Step 414); and a creation timestamp encoding a date and/or time when which the processed map data had been obtained. Processed map metadata is not limited to the aforementioned examples.

In Step 418, the processed map metadata (generated in Step 416) is published to the virtual storage pool. Specifically, in one embodiment of the invention, the processed map metadata may be stored as a data object (e.g., a file) in (or under) a virtual storage directory, of the virtual storage pool, assigned to or associated with the edge cluster. Furthermore, publishing the processed map metadata to the virtual storage pool may result in the return (or obtaining) of a processed map metadata digest. The processed map metadata digest may refer to a unique alphanumeric fingerprint that not only identifies the processed map metadata, but also identifies a virtual storage address, in the virtual storage pool, where the processed map metadata resides. The processed map metadata digest may also be referred herein as the processed map metadata CID, which may be obtained by processing the processed map metadata through any existing cryptographic hash function or algorithm (e.g., Secure Hash Algorithm 1 (SHA-1), SHA-2, Message Digest Algorithm 5 (MD5), etc.). Moreover, the virtual storage address may map to a physical storage address in the hardware edge storage, residing on the edge cluster, wherein the processed map metadata may be consolidated.

In Step 420, the processed map metadata digest (obtained in Step 318) is published to the DHT using a node identifier (ID). In one embodiment of the invention, the node ID (also referred to as a peer ID) may refer to a unique alphanumeric fingerprint that not only identifies the edge cluster, but also identifies a virtual storage address, in the virtual storage pool, where the above-mentioned virtual storage directory (assigned to the edge cluster) may resides. The node ID may also reference a mutable namespace (described above) (see e.g., FIG. 2B) associated with the edge cluster, which may share a most recent version of any processed map data for the region for which the edge cluster is responsible.

Hereinafter, in one embodiment of the invention, should additional map metadata digest(s) (identified in Step 404) remain to be processed, the process may proceed to Step 406, where a next map metadata digest may be processed. In another embodiment of the invention, should no more map metadata digest(s) remain to be processed, the process ends.

FIG. 5 shows a flowchart describing a method for preloading processed map data for upcoming regions in accordance with one or more embodiments of the invention. The various steps outlined below may be performed by an autonomous vehicle (see e.g., FIG. 1). Further, while the various steps in the flowchart(s) are presented and described sequentially, one of ordinary skill will appreciate that some or all steps may be executed in different orders, may be combined or omitted, and some or all steps may be executed in parallel.

Turning to FIG. 5, in Step 500, a region name is identified. In one embodiment of the invention, the region name may refer to a prescribed, human-readable character string that identifies an upcoming region. In turn, the upcoming region may be refer to a region (or a portion of roaded area) (see e.g., FIG. 1) that which the autonomous vehicle may be about to enter. Further, the region name may be identified or retrieved from an in-memory data structure, data object, or memory address, wherein mappings associating global positioning system (GPS) coordinates to region names may be stored.

In Step 502, a lookup is performed on a mutable namespace registry (described above) (see e.g., FIG. 2B) using the region name (identified in Step 500). Subsequently, in one embodiment of the invention, a record (also referred herein as a registry record) may be identified based on the lookup. The record may include (or specify) the region name and may link (or map) to a mutable namespace (described above) therein. Further, based on the lookup, the mutable namespace may be obtained.

In Step 504, a lookup is performed on a distributed hash table (DHT) (described above) (see e.g., FIG. 2A) using the mutable namespace (obtained in Step 502). Subsequently, in one embodiment of the invention, a record (also referred herein as a hash table record) may be identified based on the lookup. The record may be linked (or mapped) to the mutable namespace in the DHT. Further, the record may include one or more processed map metadata digest(s). A processed map metadata digest may refer to a unique alphanumeric fingerprint that not only identifies a given processed map metadata, but also identifies a given virtual storage address, in the virtual storage pool, where the given processed map metadata may reside.

In Step 506, a lookup is performed on the virtual storage pool using the processed map metadata digest (identified in Step 504). As mentioned above, the processed map metadata digest identifies a virtual storage address in the virtual storage pool. Subsequently, the processed map metadata digest identifies a location in the virtual storage pool wherein processed map metadata, from which the processed map metadata digest had been derived, may reside and wherefrom the processed map metadata may be retrieved (or obtained).

In Step 508, the processed map metadata (obtained in Step 506) is examined. In one embodiment of the invention, examination of the processed map metadata may entail identifying the various separate pieces of information (or data items) that which form the processed map metadata. From examining the processed map metadata, at least a processed map data digest is identified. The processed map data digest may refer to a unique alphanumeric fingerprint that not only identifies a given processed map data, but also identifies a given virtual storage address, in the virtual storage pool, where the given processed map data may reside.

In Step 510, a lookup is performed on the virtual storage pool using the processed map data digest (identified in Step 508). In one embodiment of the invention, the processed map data digest (i.e., virtual storage address) may identify a location in the virtual storage pool wherein processed map data, from which the processed map data digest had been derived, may reside and wherefrom the processed map data may be retrieved (or obtained).

In Step 512, the processed map data (obtained in Step 510), for the upcoming region (mentioned in Step 500), is preloaded. That is, in one embodiment of the invention, in anticipation of an autonomous vehicle entering the upcoming region, the processed map data may be copied and, subsequently, published to the virtual storage pool under the virtual storage directory assigned to the autonomous vehicle.

In Step 514, a determination is made as to whether a processed map data (for a previous region) is to be deleted. The determination may trigger upon the autonomous vehicle entering the upcoming region (mentioned in Step 500) and, concurrently, leaving the previous region. Further, the determination may be contingent on data availability policies configured and enforced by the edge cluster responsible for the previous region. Accordingly, in one embodiment of the invention, if it is determined that the processed map data, for the previous region, should be deleted, then the process may proceed to Step 516. On the other hand, in another embodiment of the invention, if it is alternatively determined that the processed map data, for the previous region, should not be deleted, then the process alternatively ends.

In Step 516, after determining (in Step 514) that the processed map data, for a previous region, should be deleted, the aforementioned processed map data is subsequently removed from the virtual storage pool.

FIG. 6 shows a computing system in accordance with one or more embodiments of the invention. The computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment of the invention, the computer processor(s) (602) may be an integrated circuit for processing instructions. For example, the computer processor(s) may be one or more cores or micro-cores of a central processing unit (CPU) and/or a graphics processing unit (GPU). The computing system (600) may also include one or more input devices (610), such as a touchscreen, keyboard, mouse, microphone, touchpad, electronic pen, or any other type of input device. Further, the communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

In one embodiment of the invention, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for loading autonomous vehicle navigation guidance, comprising:
identifying a region name associated with a region;
obtaining a mutable namespace based on the region name;
obtaining a processed map metadata digest based on the mutable namespace;
obtaining processed map metadata based on the processed map metadata digest;
obtaining processed map data based on the processed map metadata; and
loading the processed map data, to navigationally guide an autonomous vehicle within or through the region.

2. The method of claim 1, wherein obtaining the mutable namespace based on the region name, comprises:
performing a lookup on a mutable namespace registry using the region name, to identify a registry record comprising the region name and the mutable namespace; and
retrieving the mutable namespace from the registry record,
wherein the mutable namespace is associated with an edge cluster responsible for the region.

3. The method of claim 1, wherein obtaining the processed map metadata digest based on the mutable namespace, comprises:
performing a lookup on a distributed hash table (DHT) using the mutable namespace, to identify a key-record pair comprising the mutable namespace and a record; and
examining the record, to identify the processed map metadata digest; and
retrieving the processed map metadata digest from the record.

4. The method of claim 1, wherein obtaining the processed map metadata based on the processed map metadata digest, comprises:
performing a lookup on a virtual storage pool using the processed map metadata digest, to identify a virtual storage address; and
retrieving the processed map metadata from the virtual storage address.

5. The method of claim 1, wherein obtaining the processed map data based on the processed map metadata, comprises:
examining the processed map metadata, to identify a processed map data digest therein;
performing a lookup on a virtual storage pool using the processed map data digest, to identify a virtual storage address; and
retrieving the processed map data from the virtual storage address.

6. The method of claim 1, further comprising:
generating map data for the region while the autonomous vehicle is navigating the region;
publishing the map data to a virtual storage pool, to obtain a map data digest;
generating map metadata describing the map data and comprising the map data digest;
publishing the map metadata to the virtual storage pool, to obtain a map metadata digest;
generating a hash table key using at least the region name; and
publishing the map metadata digest to a distributed hash table (DHT) using the hash table key.

7. The method of claim 1, wherein the region comprises at least a portion of a roaded area, wherein the roaded area comprises at least one path on which the autonomous vehicle uses to navigate within or through the region.

8. A system, comprising:
a virtual storage pool; and
an autonomous vehicle comprising a first computer processor operatively connected to the virtual storage pool, and programmed to:
identify a region name associated with a region;
obtain a mutable namespace based on the region name;
obtain a processed map metadata digest based on the mutable namespace;
obtain processed map metadata based on the processed map metadata digest;
obtain processed map data based on the processed map metadata; and
load the processed map data, to navigationally guide the autonomous vehicle within or through the region

9. The system of claim 8, wherein the virtual storage pool represents shared data storage aggregated and virtualized from disparate physical storage resources comprising physical vehicle storage residing on the autonomous vehicle.

10. The system of claim 9, further comprising:
an edge cluster comprising a second computer processor operatively connected to the virtual storage pool,
wherein the disparate physical storage resources further comprise physical edge storage residing on or operatively connected to the edge cluster.

11. The system of claim 10, wherein the edge cluster is responsible for the region.

12. The system of claim 10, further comprising:
a cloud backend comprising a third computer processor operatively connected to the virtual storage pool,
wherein the disparate physical storage resources further comprise physical cloud storage residing on the cloud backend.

13. The system of claim 8, wherein the virtual storage pool is managed by a content-addressable, peer-to-peer, distributed file system.

14. The system of claim 13, wherein the content-addressable, peer-to-peer, distributed file system is an Interplanetary File System (IPFS).

15. A non-transitory computer readable medium (CRM) comprising computer readable program code, which when executed by a computer processor, enables the computer to perform a method, the method comprising:
identifying a region name associated with a region;
obtaining a mutable namespace based on the region name;
obtaining a processed map metadata digest based on the mutable namespace;
obtaining processed map metadata based on the processed map metadata digest;
obtaining processed map data based on the processed map metadata; and
loading the processed map data, to navigationally guide an autonomous vehicle within or through the region.

16. The non-transitory CRM of claim 15, wherein obtaining the mutable namespace based on the region name, comprises:
performing a lookup on a mutable namespace registry using the region name, to identify a registry record comprising the region name and the mutable namespace; and
retrieving the mutable namespace from the registry record,
wherein the mutable namespace is associated with an edge cluster responsible for the region.

17. The non-transitory CRM of claim 15, wherein obtaining the processed map metadata digest based on the mutable namespace, comprises:
performing a lookup on a distributed hash table (DHT) using the mutable namespace, to identify a key-record pair comprising the mutable namespace and a record; and
examining the record, to identify the processed map metadata digest; and
retrieving the processed map metadata digest from the record.

18. The non-transitory CRM of claim 15, wherein obtaining the processed map metadata based on the processed map metadata digest, comprises:
performing a lookup on a virtual storage pool using the processed map metadata digest, to identify a virtual storage address; and
retrieving the processed map metadata from the virtual storage address.

19. The non-transitory CRM of claim 15, wherein obtaining the processed map data based on the processed map metadata, comprises:
examining the processed map metadata, to identify a processed map data digest therein;
performing a lookup on a virtual storage pool using the processed map data digest, to identify a virtual storage address; and
retrieving the processed map data from the virtual storage address.

20. The non-transitory CRM of claim 15, the method further comprising:
generating map data for the region while the autonomous vehicle is navigating the region;
publishing the map data to a virtual storage pool, to obtain a map data digest;
generating map metadata describing the map data and comprising the map data digest;
publishing the map metadata to the virtual storage pool, to obtain a map metadata digest;
generating a hash table key using at least the region name; and
publishing the map metadata digest to a distributed hash table (DHT) using the hash table key.
